(19) United States
(12) Patent Application Publication
(10) Pub. No.: US 2017/0061361 A1
(43) Pub. Date: Mar. 2, 2017

(54) ON-LINE FELLOWSHIP ENHANCEMENT SYSTEM FOR OFF-LINE COMPANY ORGANIZATION

(71) Applicant: Bang Guen CHI, Seoul (KR)

(72) Inventor: Bang Guen CHI, Seoul (KR)

(21) Appl. No.: 15/221,734

(22) Filed: Jul. 28, 2016

(30) Foreign Application Priority Data
Aug. 27, 2015 (KR) 10-2015-0120815

(51) Int. Cl. G06Q 10/06; H04W 4/12; G06F 17/30; H04L 29/08

(52) U.S. Cl. CPC G06Q 10/063114; H04L 67/22; H04L 67/02; H04W 4/12; G06F 17/30312; G06F 17/30345; G06F 17/30864

(57) ABSTRACT

The present disclosure provides a method of operating an on-line fellowship enhancement system to enhance a fellowship between members of an off-line company organization, wherein the system includes member terminals of members of the off-line company organization, and a management server to manage the system, the sever determining whether the first member achieves the fellowship-related assignment; upon determination that the first member achieves the fellowship-related assignment, the server allocating or updating an activity score to the first member; and the server storing the allocated or updated activity score to a member database in the server.

### CROSS-REFERENCE TO RELATED APPLICATION

This application claims the benefit of Korea Patent Application No. 10-2015-0120815, filed on Aug. 27, 2015, the entire content of which is incorporated herein by reference for all purposes as if fully set forth herein.

### BACKGROUND

Field of the Present Disclosure

The present disclosure relates to a method of operating an on-line fellowship enhancement system to enhance a fellowship between members of an off-line company organization and an on-line fellowship enhancement system to enhance a fellowship between members of an off-line company organization.

Discussion of the Related Art

The company organization has a main purpose to get an interest. Thus, human relationships may be ignored. Further, during the job process, the members in the company organization may have conflicts. Thus, there is a need for develop a more-friendly working environment. In this connection, a prior art document may be a Korean patent application number 2006-0114986.

### SUMMARY

Thus, the present disclosure provides a method of operating an on-line fellowship enhancement system to enhance a fellowship between members of an off-line company organization and an on-line fellowship enhancement system to enhance a fellowship between members of an off-line company organization.

In one aspect, there is provided a method of operating an on-line fellowship enhancement system to enhance a fellowship between members of an off-line company organization, wherein the system includes member terminals of members of the off-line company organization, a management server to manage the system, and an administrator terminal of an administrator of the off-line company organization, wherein wireless or wired communications are executed between the member terminals and the server, and between the server and the administrator terminal, wherein messages are communicated between the member terminals via the server, wherein the method comprises: when it is determined that a first member has issued and/or received a predetermined number of messages within a predetermined period, the server indicating a fellowship-related assignment to the first member via a member terminal of the first member; the sever determining whether the first member achieves the fellowship-related assignment; upon determination that the first member achieves the fellowship-related assignment, the server allocating or updating an activity score to the first member; and the server storing the allocated or updated activity score to a member database in the server, wherein the fellowship-related assignment is achieved off-line.

In one implementation, the sever determining whether the first member achieves the fellowship-related assignment comprises: the server pre-storing a keyword associated with the assignment therein; the server receiving messages from the terminal of the first member, wherein the messages from the terminal of the first member are directed to other members of the company organization; the server searching the keyword for the messages from the terminal of the first member; when the keyword is discovered on the messages, the server determining that the first member achieves the fellowship-related assignment.

In one implementation, the first member operates a homepage, wherein the sever determining whether the first member achieves the fellowship-related assignment comprises: the server pre-storing a keyword associated with the assignment therein; the server accessing the homepage; the sever searching the keyword for a text posted by the first member on the homepage; when the keyword is discovered on the text, the server determining that the first member achieves the fellowship-related assignment.

In one implementation, the method further comprises: the server pre-storing therein background images and character images to be combined with the background images; the terminal of the first member selecting a background image from the background images in the server; the server allocating a character image to the first member based on the allocated or updated activity score; and the terminal of the first member combing the allocated character image with the selected back ground image.

In one implementation, the method further comprises: the server receiving information about the multiple members to establish an on-line company organization corresponding to the off-line company organization.

In one implementation, the method further comprises: the administrator terminal receiving information about a new candidate member and approving a membership thereof in the on-line company organization based on the information.

In one implementation, the method further comprises: the sever counting a number of messages to be issued to the first terminal, wherein the messages are issued from other members in the company organization; the sever determining whether the counts exceed a predetermined number; upon determination that the counts do not exceed the predetermined number, the server disallowing the messages to reach the first terminal; or upon determination that the counts exceed the predetermined number, the server allowing the messages to reach the first terminal.

In one implementation, the fellowship-related assignment to the first member is set based on a schedule set to the first member by the server.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram for a system for managing an on-line company organization in accordance with a first embodiment of the present disclosure.

FIG. 2 is a flow chart of a method of operating the system for managing the on-line company organization in accordance with the first embodiment of the present disclosure.

FIG. 3 shows exemplary interfaces for a membership application in the on-line company organization, in accordance with one embodiment of the present disclosure.

FIG. 4 shows an exemplary interface for activity scores of a member in the on-line company organization, in accordance with one embodiment of the present disclosure.

FIG. 5 shows an exemplary interface for issuing a message in a system for managing the on-line company organization, in accordance with one embodiment of the present disclosure.

FIG. 6 shows an exemplary interface for a received message in a system for managing the on-line company organization, in accordance with one embodiment of the present disclosure.

FIG. 7 shows an exemplary interface for an assignment (or mission) message in a system for managing the on-line company organization, in accordance with one embodiment of the present disclosure.

FIG. 8 shows exemplary interfaces for activity scores of a member in the on-line company organization, in accordance with one embodiment of the present disclosure.

FIG. 9 is a block diagram for a system for managing an on-line company organization in accordance with a second embodiment of the present disclosure.

FIG. 10 is a flow chart of a method of operating the system for managing the on-line company organization in accordance with the second embodiment of the present disclosure.

FIG. 11 shows exemplary interfaces for messages between members in the on-line company organization, in accordance with one embodiment of the present disclosure.

### DETAILED DESCRIPTIONS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

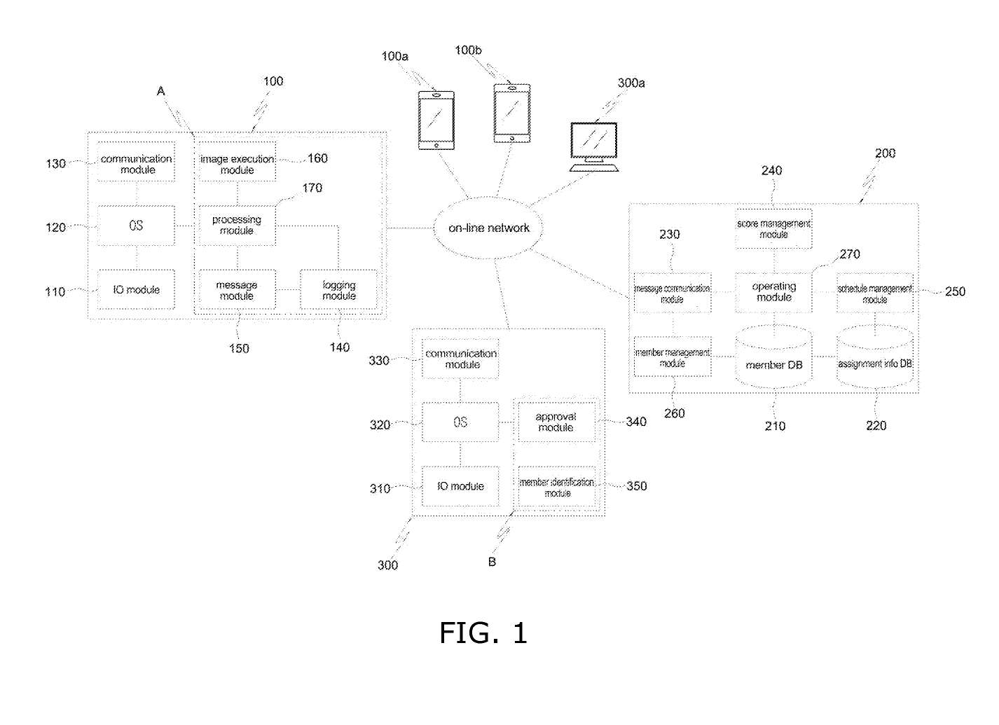

FIG. 1 is a block diagram for a system for managing an on-line company organization in accordance with a first embodiment of the present disclosure.

The system for managing the on-line company organization in accordance with a first embodiment of the present disclosure may include a member terminal 100 of an on-line company organization member, a management server 200 communicating with the member terminal 100, and an administrator terminal 300 of an administrator for managing the on-line company organization over a network. The administrator terminal 300 may communicate with the management server 200 and the member terminal 100 over the network.

The member terminal 100 may comprise a mobile phone, desktop computer, laptop, or any other communication device that the member may utilize to access the management server 200. The member terminal 100 may include various application programs A such as a message module 150 to send or receive a message, an image execution module 160 to search for and output a screen image or effect image, etc., a logging module 140 to store the message, etc.; and a processing module 170 to process the application programs A. the member terminal 100 may include an input/output module 110 to input data and output a screen or sound, etc., a communication module 130 to realize on-line communications, and an operating system (OS) 120 to control operations of the application programs A and input/output module 110 and communication module 130. The input/output module 110 and communication module 130 and OS 130 are well known to the skilled person to the art.

The management server 200 may communicate with the member terminals 100, 100a, 100b and administrator terminals 300, 300a and process various assignments related to member's activities. To this end, the management server 200 may include a member DB 210 to store therein member information about registered members, an assignment information DB 220 to store therein various assignments information about assignments to be executed according to instructions set by the management server 200, a message communication module 230 to communicate messages between the member terminals 100, 100a, 100b, an activity score management module 240 to generate and deposit an activity score based on a member's activity, a scheduler module 250 to manage schedules of the members, a member management module 260 to manage member information stored in the member DB 210, and an operating module 270 to operate the DBs 210, 220, and the modules 230, 240, 250, 260 of the management server 200.

The administrator terminal 300 may include an application program B to allow the administrator of the on-line company organization to manage the members thereof. The application program B may include an approval module 340 to approve or disapprove an application of a membership in the on-line company organization, and a member monitoring module 350 to monitor statuses or circumstances of the on-line company organization and manage and output the member information via the administrator's manipulation. The administrator terminal 300 may comprise a mobile phone, desktop computer, laptop, or any other communication device that the administrator may utilize to access the management server 200. The administrator terminal 300 may comprise an input/output module 310 and communication module 330 and OS 320 for the application program B.

Hereinafter, an operation process of the system for managing the on-line company organization will be described.

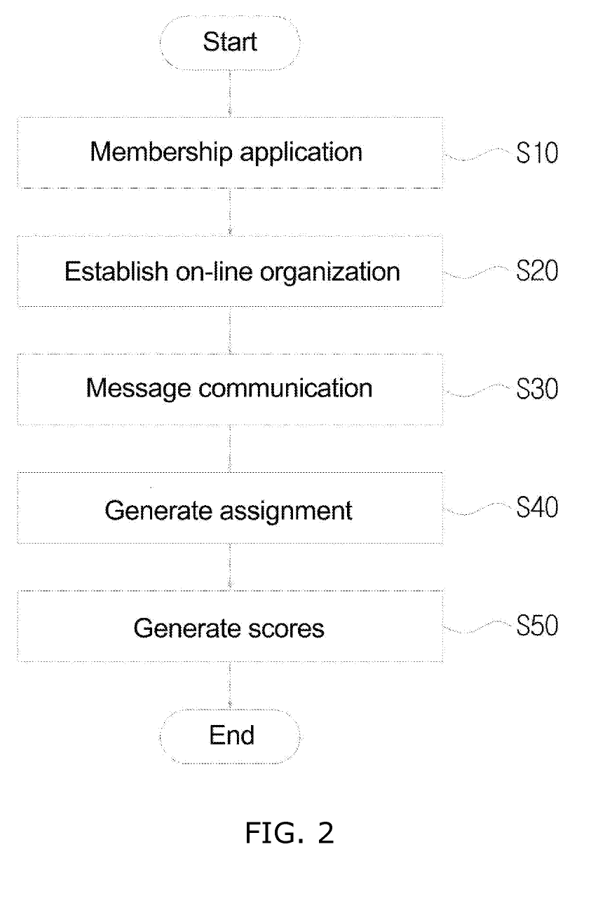

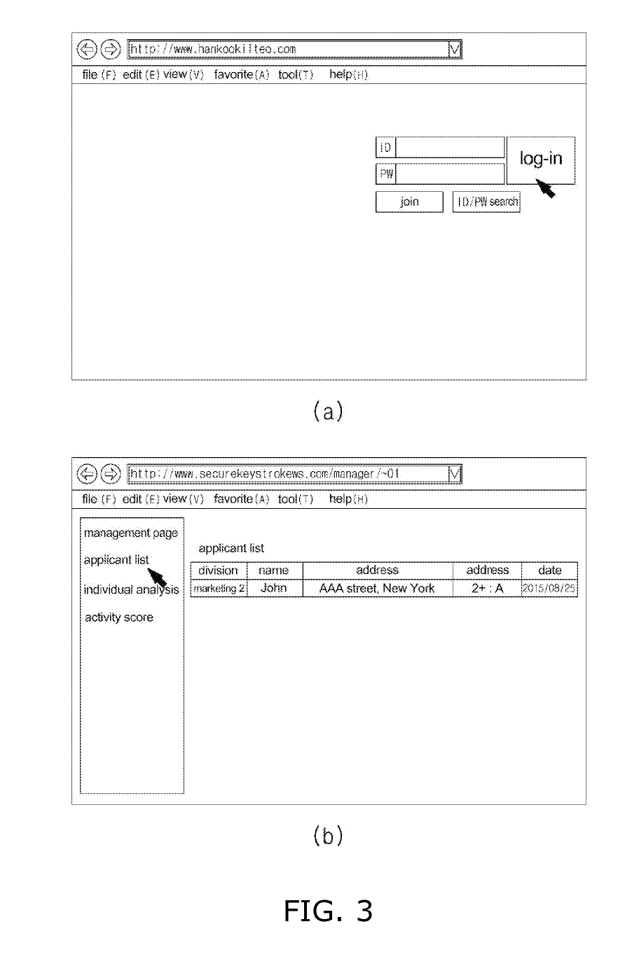

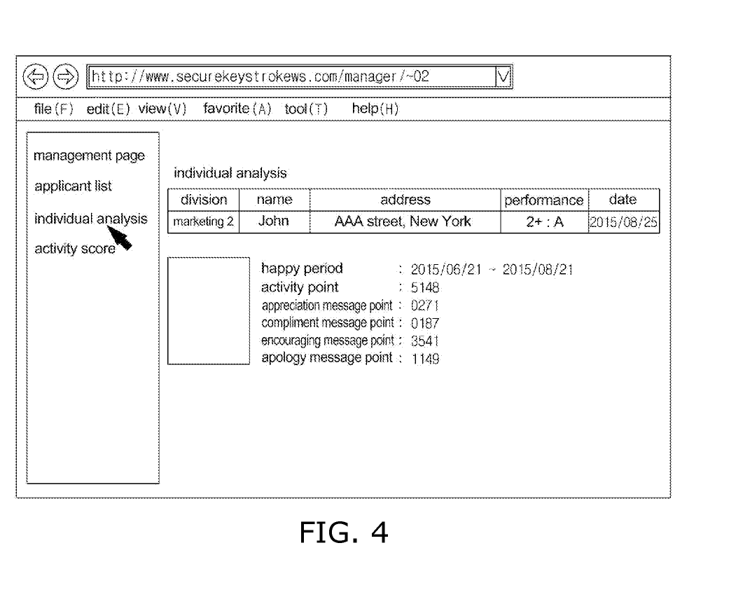

FIG. 2 is a flow chart of a method of operating the system for managing the on-line company organization in accordance with the first embodiment of the present disclosure. FIG. 3 shows exemplary interfaces for a membership application in the on-line company organization, in accordance with one embodiment of the present disclosure. FIG. 4 shows an exemplary interface for activity scores of a member in the on-line company organization, in accordance with one embodiment of the present disclosure.

S10: Membership Application

A candidate member accesses a website operated by the management server 200 using the member terminal 100 thereof to join in the on-line company organization and may download an on-line company organization application from the management server 200. The on-line company organization application may include the logging module 140 and the message module 150 and the image execution module 160 and the processing module 170. Thus, the logging module 140 and the message module 150 and the image execution module 160 and the processing module 170 may be installed into the member terminal 100. In other words, the application program A as shown in FIG. 1 may be installed into the member terminal 100.

Then, the candidate member may apply for the membership into the on-line company organization as shown in FIG. 3a. That is, the candidate member may input an ID (identification), PW (password), etc. and may log in the website operated by the management server 200.

In addition to this, the management server 200 may provide a member dedicated QR code and/or domain address for the member with the approved membership. Thus, the member may log in the management server 200 using the dedicated QR code and/or domain address without entering the ID/PW, etc.

S20: On-Line Company Organization Establishment

In the present disclosure, the members in an off-line company organization may join in the on-line company organization to allow efficient communications and conflicts settlements and encouraging job environments among the off-line members. For this, the management server 200 may establish the on-line company organization and manage the on-line company organization.

Upon the completion of the membership application, the management server 200 may store member information into the member DB 210. The member management module 260 may search for the member information from the member DB 210 and inform the administrator terminal 300 of the searched member information. The message communication module 230 may inform the administrator terminal 300 of a message to indicate that the searched member information for the candidate member has been sent to the administrator via the administrator terminal 300. Then, the administrator may access the management server 200 via the administrator terminal 300. As shown in FIG. 3b, the administrator may check the member information. Then, the administrator may determine whether to approve the membership of the candidate member using the administrator terminal 300. Upon the approval, the approval module 340 of the administrator terminal 300 may send the approval result to the member management module 260. Then, the member management module 360 may permit the candidate member to have the membership into the on-line company organization.

Upon the completion of the approval, the member or administrator may access various menus on the website operated by the management server 200. The member management module 260 may monitor the various activities scores based on activities of the members as shown in FIG. 4. The various activities scores will be described in details later.

The member management module 360 and approval module 340 installed in the administrator terminal 300 may be downloaded from the management server 200.

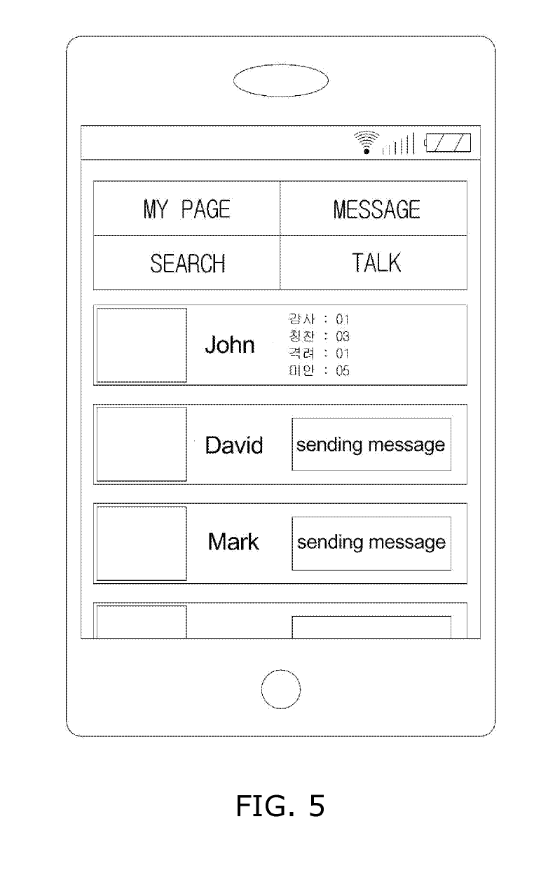

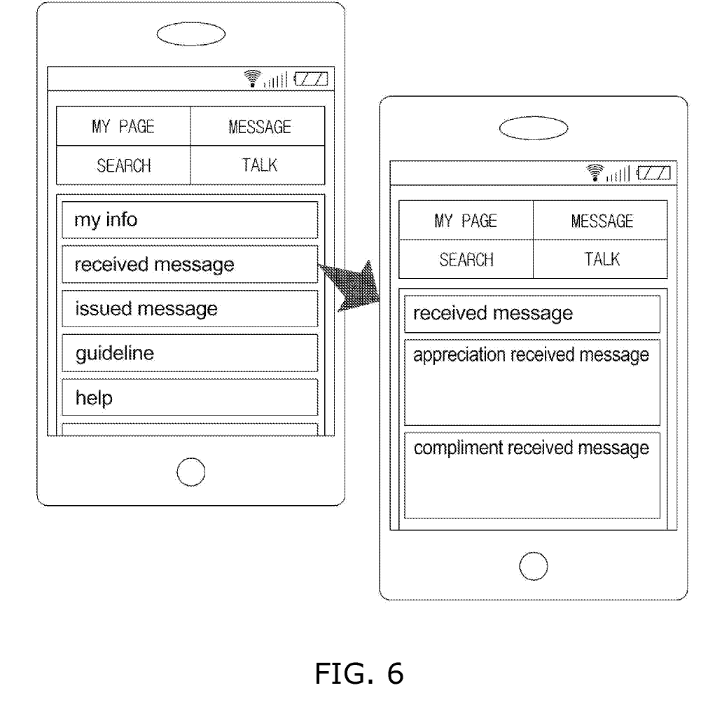

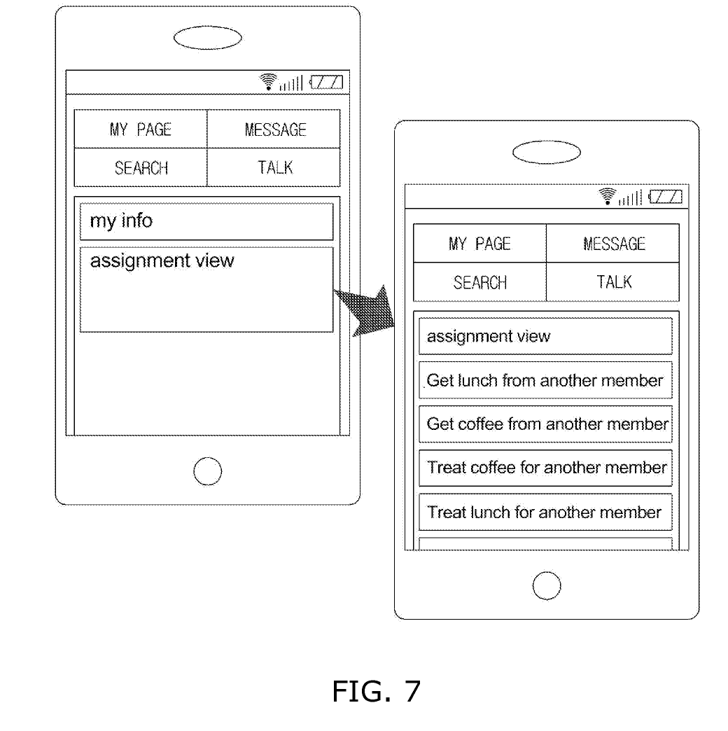

FIG. 5 shows an exemplary interface for issuing a message in a system for managing the on-line company organization, in accordance with one embodiment of the present disclosure. FIG. 6 shows an exemplary interface for a received message in a system for managing the on-line company organization, in accordance with one embodiment of the present disclosure. FIG. 7 shows an exemplary interface for an assignment (or mission) message in a system for managing the on-line company organization, in accordance with one embodiment of the present disclosure.

S30: Message Communication

The members in the on-line company organization may communicate messages with one another. More specifically, a member to send the message may allow the member terminal 100, strictly, the message module 150 to display a message input page. This message input page is shown in FIG. 5. The message input page may include an appreciation message, compliment message, encouraging message, and/or apology message.

When the sender member selects one from the appreciation message, compliment message, encouraging message, and/or apology message, the message module 150 may display a message input window corresponding to the selected message. The message module 150 may send the input message from the sender member to a member terminal 100 of a receiver member. In this connection, the message module 150 may monitor a type and/or number of the sent messages from the sender member. Further, the message module 150 may output the member list of the on-line company organization [symbol] member and thus send the type and/or number of the sent messages from the sender member to the listed members. Thus, all of the members in the on-line company organization may be aware of the members with smaller numbers of the message issues. This may allow the members with smaller numbers of the message issues to be motivated to send more messages to other members.

The message communication module 230 of the management server 200 may allow exchanges of the message between the members in the on-line company organization. The message module of the member terminal of the receiver member may receive the message, and the input/output module may output the message. The receiver member may check the message. The receiver member may send a reply to the sender member.

In one embodiment, the message module 150 or message communication module 230 may count the received messages. When the counts do not reach a predetermine value, the received messages may be prevented to be output to the receiver member. For example, when the predetermine value is set to 3, the counts of the message receipts by the receiver member reaches threes, the message module 150 or message communication module 230 may allow first, second, and third messages to be outputted to the receiver member. Otherwise, the counts of the message receipts by the receiver member reaches two, the message module 150 or message communication module 230 may disallow the first and second messages to be outputted to the receiver member. This may motivate the receive member with smaller counts of the message receipts to more actively communicate the messages with other members. When the counts do not reach the predetermine value, the message module 150 or message communication module 230 may allow information on the sender member of the message received from the receiver member to be output to the receiver member.

In this way, this embodiment may motivate the message communications between the members in the company organization to improve unity or fellowship therebetween. This may lead to more friendly job environment and more efficient job performance and enhanced cooperation.

The message type may not be limited to the appreciation message, compliment message, encouraging message, and apology message. The present disclosure may not be limited thereto.

S40: Assignment Generation

When a certain member has received or issued a predetermined number of the messages within a predetermined period, the operating module 270 may search for assignment information in the assignment information DB 220 and issue the searched assignment to the member. As used herein, the “assignment” may refer to a fellowship-related assignment to the member. In one example, as shown in FIG. 7, the fellowship-related assignment may include “treat a lunch for another member”, “treat a coffee for another member”, “get a lunch from another member”, “get a coffee from another member”, etc. The present disclosure may not be limited thereto. That is, the fellowship-related assignment refers to an off-line activity to improve the unity or fellowship between the members.

The operating module 270 may find out the fellowship-related assignment from the assignment information DB 220 in a random manner and then assign the assignment to the member. In an alternative, the operating module 270 may find out the fellowship-related assignment from the assignment information DB 220 in a random manner based on the schedule of the member set by the schedule management module 250 and then assign the assignment to the member.

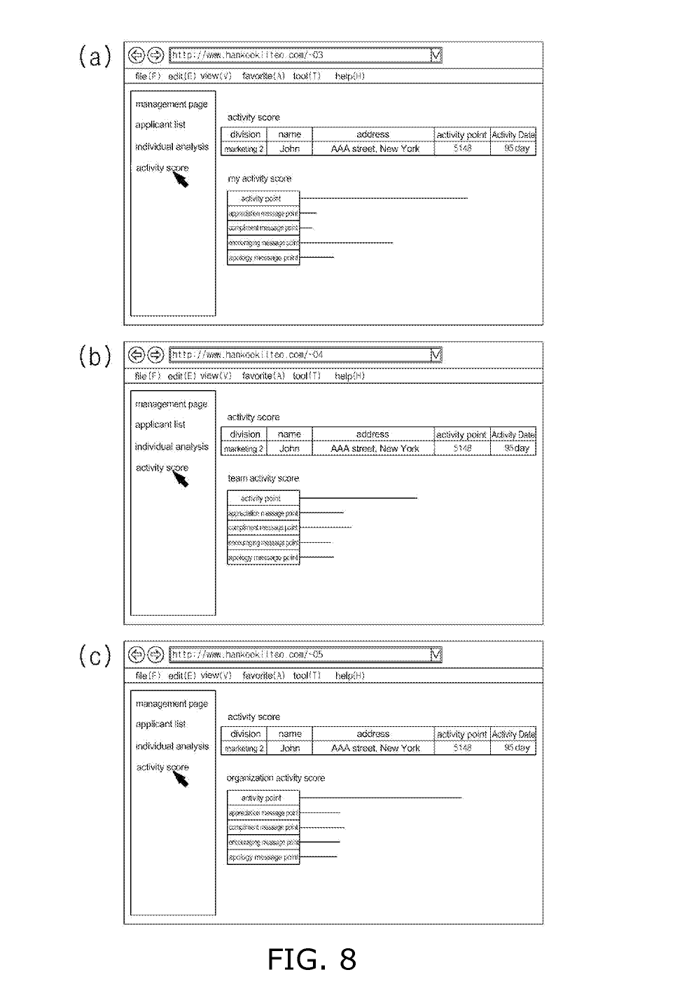

FIG. 8 shows exemplary interfaces for activity scores of a member in the on-line company organization, in accordance with one embodiment of the present disclosure.

S50: Activity Score Generation

The activity score management module 240 may monitor the counts of the message receipts and issues and the fellowship-related assignment achievement, etc. for the certain member. The activity score management module 240 may create and update the activity score for the member based on the counts of the message receipts and issues and the fellowship-related assignment achievement, etc.

This generated or updated activity score may be stored in the member DB 210. Thus, the member may check the activity score from the management server 200 as shown in FIG. 8.

FIG. 8a shows an example interface outputting an activity score for an individual member. FIG. 8b shows an example interface outputting an average activity score for a certain task team or division in the company organization. FIG. 8c shows an example interface outputting an average activity score for the entire company organization. The members may check the activity score for an individual member, the average activity score for the certain task team or division, and/or the average activity score for the entire company organization. This may allow the members to motivate the activities more actively. The administrator may access the management server 200 to check the activity score for an individual member, the average activity scores for the certain task team or division, and/or the average activity score for the entire company organization.

The activity score management module 240 may generate a character image for a certain member based on the activity score and/or activity type of the member, and then combine the character image with a specific background image. Thus, the member may change a character image based on the activity score and/or activity type thereof.

In one example, the background image is an oasis in a desert. The character image corresponding to the activity score may be a fruit tree, a grass, and/or an animal, etc. Thus, the activity score management module 240 may generate the character image based on the activity score. Great activity scores and many activity type may lead to abundance or greenness in the oasis in a desert. This may allow the member to motivate performing the activity actively.

The background image may be downloaded into the member DB after the member joins in the specific on-line company organization. The character images may be downloaded into the member DB after the completion of the activity.

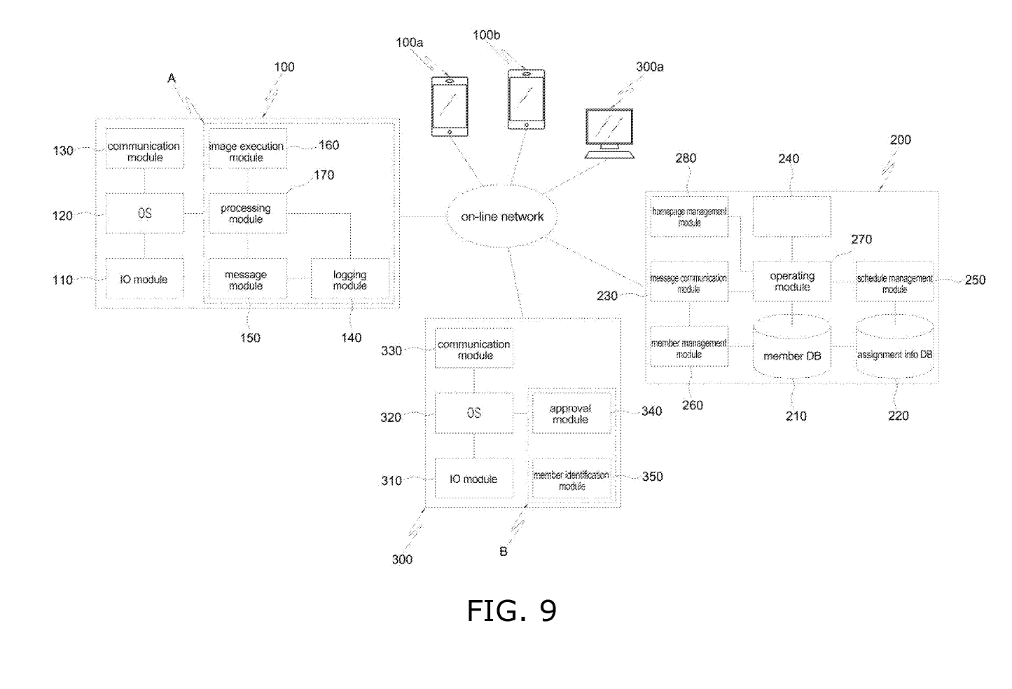

FIG. 9 is a block diagram for a system for managing an on-line company organization in accordance with a second embodiment of the present disclosure.

The system for managing an on-line company organization in accordance with a second embodiment of the present disclosure may include a member terminal 100 of an on-line company organization member, a management server 200 communicating with the member terminal 100, and an administrator terminal 300 of an administrator for managing the on-line company organization over a network. The administrator terminal 300 may communicate with the management server 200 and the member terminal 100 over the network.

The member terminal 100 may be similar to that in the first embodiment. The administrator terminal 300 may be similar to that in the first embodiment. The management server 200 may be similar to that in the first embodiment except for the addition of a homepage management module 280. Thus, the system for managing an on-line company organization in accordance with a second embodiment of the present disclosure may manage a homepage of an individual, a team, and/or a company. When the homepage is directed to an individual, the homepage may be a blog. Thus, the member may upload the private image or story or a public image or story. Another member may post a comment on the blog.

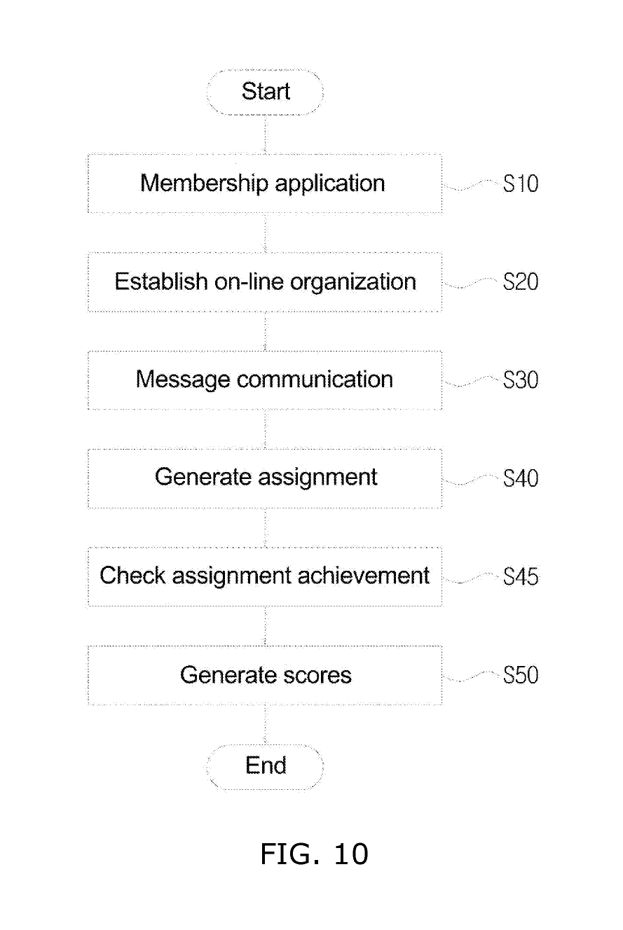

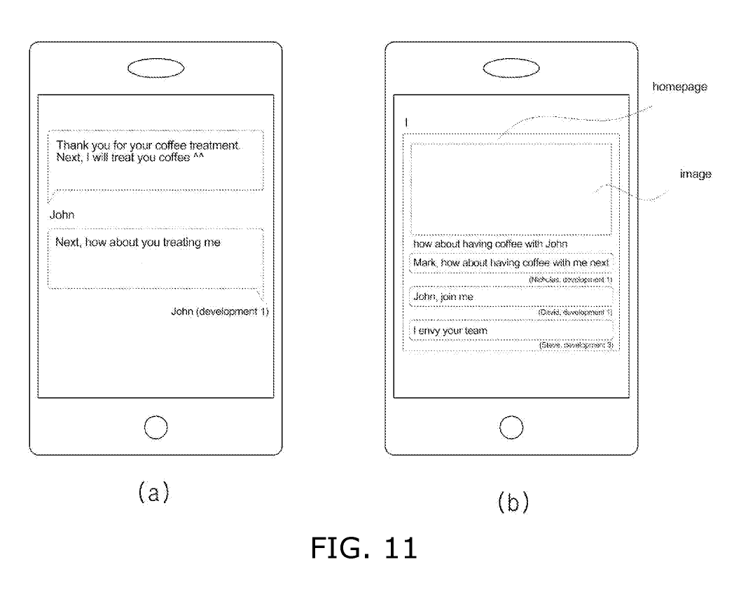

FIG. 10 is a flow chart of a method of operating the system for managing the on-line company organization in accordance with the second embodiment of the present disclosure. FIG. 11 shows exemplary interfaces for messages or comments or reply between members in the on-line company organization, in accordance with one embodiment of the present disclosure.

S45: Monitoring Assignment Achievement

The activity score management module 240 may check the member's activity. For this, the operating module 270 may determine whether the member achieves the assignment. As described above, the assignment may not be achieved on-line but off-line. Thus, in order to determine whether the member achieves the assignment, the operating module 270 may search an associated key word with the assignment achievement for the issued or received messages until the assignment achievement is due. Then, the operating module 270 may determine, based on the keyword matching, whether the member achieves the assignment. To this end, the operating module 270 may include the associated key word with the assignment achievement into the assignment information.

In one example, when the assignment to a certain member is a “treat a coffee to another member, the operating module 270 may monitor a message as shown in FIG. 11a until the assignment achievement is due. In this connection, the associated key word with the assignment achievement may be “coffee” and/or “have”. When the matching for the associated key word occurs for the message, it may be determined that the assignment is done by the member. Thus, at the activity score creation S50, the activity scores management module 240 give the activity score to the member.

In an alternative, the operating module 270 may search the story or image posted by the member on the homepage managed by the homepage management module 280. The operating module 270 may search for the associated key word with the assignment achievement on the comment or reply to the story or image posted by the member. As shown in FIG. 11b, when the associated key word with the assignment achievement “coffee” is identified on the comment or reply, it may be determined that the assignment is done by the member. Thus, at the activity score creation S50, the activity scores management module 240 give the activity score to the member.

The present system for managing the on-line company organization may allow the member's off-line activity to be promoted actively based on the activity score notification. This may improve the fellowship between the member in the company.

The various module in the present disclosure may be implemented in a hardware or software module. As used herein, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method of operating an on-line fellowship enhancement system to enhance a fellowship between members of an off-line company organization, wherein the system includes member terminals of members of the off-line company organization, a management server to manage the system, and an administrator terminal of an administrator of the off-line company organization, wherein wireless or wired communications are executed between the member terminals and the server, and between the server and the administrator terminal, wherein messages are communicated between the member terminals via the server, wherein the method comprises:
when it is determined that a first member has issued and/or received a predetermined number of messages within a predetermined period, the server indicating a fellowship-related assignment to the first member via a member terminal of the first member;
the sever determining whether the first member achieves the fellowship-related assignment;
upon determination that the first member achieves the fellowship-related assignment, the server allocating or updating an activity score to the first member; and
the server storing the allocated or updated activity score to a member database in the server,
wherein the fellowship-related assignment is achieved off-line.

2. The method of claim 1, wherein the sever determining whether the first member achieves the fellowship-related assignment comprises:
the server pre-storing a keyword associated with the assignment therein;
the server receiving messages from the terminal of the first member, wherein the messages from the terminal of the first member are directed to other members of the company organization;
the server searching the keyword for the messages from the terminal of the first member;
when the keyword is discovered on the messages, the server determining that the first member achieves the fellowship-related assignment.

3. The method of claim 1, wherein the first member operates a homepage, wherein the sever determining whether the first member achieves the fellowship-related assignment comprises:
the server pre-storing a keyword associated with the assignment therein;
the server accessing the homepage;
the sever searching the keyword for a text posted by the first member on the homepage;
when the keyword is discovered on the text, the server determining that the first member achieves the fellowship-related assignment.

4. The method of claim 1, wherein the method further comprises:
the server pre-storing therein background images and character images to be combined with the background images;
the terminal of the first member selecting a background image from the background images in the server;
the server allocating a character image to the first member based on the allocated or updated activity score; and
the terminal of the first member combing the allocated character image with the selected back ground image.

5. The method of claim 1, wherein the method further comprises:
the server receiving information about the multiple members to establish an on-line company organization corresponding to the off-line company organization.

6. The method of claim 5, wherein the method further comprises:
the administrator terminal receiving information about a new candidate member and approving a membership thereof in the on-line company organization based on the information.

7. The method of claim 1, wherein the method further comprises:
the sever counting a number of messages to be issued to the first terminal, wherein the messages are issued from other members in the company organization;
the sever determining whether the counts exceed a predetermined number;
upon determination that the counts do not exceed the predetermined number, the server disallowing the messages to reach the first terminal; or
upon determination that the counts exceed the predetermined number, the server allowing the messages to reach the first terminal.

8. The method of claim 1, wherein the fellowship-related assignment to the first member is set based on a schedule set to the first member by the server.
